(19) United States
(12) Patent Application Publication
(10) Pub. No.: US 2015/0140193 A1
(43) Pub. Date: May 21, 2015

(54) COMPOSITION FOR THE PREPARATION OF HOMEMADE FROZEN CONFECTIONS

(71) Applicants: Nilesh Desai, Bakersfield, CA (US); Mandeep Rajendra Patel, Bakersfield, CA (US); Josephine Enriquez Lometillo, Bakersfield, CA (US)

(72) Inventors: Nilesh Desai, Bakersfield, CA (US); Mandeep Rajendra Patel, Bakersfield, CA (US); Josephine Enriquez Lometillo, Bakersfield, CA (US)

(73) Assignee: NESTEC S.A., Vevey (CH)

(21) Appl. No.: 14/367,777

(22) PCT Filed: Dec. 17, 2012
(86) PCT No.: PCT/EP2012/075832

§ 371 Date: Jun. 20, 2014

Related U.S. Application Data
(60) Provisional application No. 61/578,988, filed on Dec. 22, 2011.

(30) Foreign Application Priority Data
Dec. 22, 2011 (EP) 11195414.5

(51) Int. Cl. A23G 9/34; A23G 9/52; A23G 9/40

(52) U.S. Cl. CPC A23G 9/34; A23G 9/40; A23G 9/52; A23V 2002/00
USPC 426/583; 426/580; 426/588; 426/660; 426/584

(57) ABSTRACT

The present invention relates to a shelf-stable composition for the preparation of a frozen confection comprising: (i) a sweetening agent; (ii) a dairy fat; and (iii) one or more polysaccharide having a Dextrose Equivalent (DE) value of maximum 40; with the proviso that the composition does not comprise added emulsifiers or stabilizers. The present invention also relates to a method of preparing a frozen confection by mixing said composition with ice and an edible liquid and blend the mixture.

### TECHNICAL FIELD OF THE INVENTION

The present invention relates to frozen confections, such as ice creams. In particular the present invention relates to a shelf-stable composition for the preparation of homemade frozen confections. The invention furthermore relates to frozen confections comprising the composition as well as methods of preparing the frozen confections.

### BACKGROUND OF THE INVENTION

Frozen confections and frozen beverages are popular products. The products are especially popular amongst consumers at summertime, but are also popular during other seasons. Frozen confections and frozen beverages in general become more and more popular. Besides, the market for frozen beverages as refreshing drinks is rapidly growing.

It has over the recent years been more and more popular to produce ice cream and other frozen confections at home. Some powders are available on the market to prepare frozen confections at home. However, all of these frozen confection powders currently being on the market contain emulsifiers and/or stabilizers.

For example in the Chinese patent application CN 1522588A an ice cream powder is known which consist of 35-50% sucrose, 35-445% whole milk powder, 5-10% maltodextrin, 5-15% vegetable fat powder, 2.0-5.0% egg yolk powder, 1.0-2.0% lecithin and 1.5-2.0% guar gum by weight percentages. Thus, the composition comprises lecithin and egg yolk as an emulsifier and the guar gum as a stabilizer.

From the US patent application U.S. Pat. No. 6,468,576, a method of preparing a slush beverage from a liquid concentrate composition containing emulsifier(s), milk protein(s), freeze point depressant(s), sedimentation stabilizer(s), gelation stabilizer(s), flavouring(s) and water is known. The emulsifiers used include monoglycerides, diglycerides, lecithin, or combinations thereof. The sedimentation stabilizer includes kappa-carrageenans, kappa(II)-carrageenans, lambda-carrageenans, iota-carrageenans, carboxymethylcellulose, microcrystalline cellulose, other cellulosics, or combinations thereof. Gelation stabilizers include gum Arabic, food-grade phosphates, food-grade polyphosphates, or combinations thereof.

In the European patent application EP 0242 056 A2 a powdered composition for the manufacture of a tart dairy drink or machine produced soft ice by adding water or milk is described. The composition comprises about 1 to about 15% of an edible acid, about 0 to about 6% of a pretreated starch, about 0 to 10% of a dried cultured milk powder, about 0.3-90% sweeteners, about 0 to 7% colours and flavours, about 0 to 50% milk powder and a mixture of at least two gums selected from guar gum, carob gum and xanthan gum, each of said individual gums being present in said mixture in an amount from about 0.3 to 4% and the total amount of said mixture of gums being from about 2.3% to 8% by wt of the powdered composition.

Existing compositions for preparing ice cream or iced beverages are for industrial and/or commercial use, especially for quick service restaurants. These compositions include stabilizers and/or emulsifiers and are often not shelf stable.

Hence, there is an unmet need for a composition for preparing frozen confections which are free from stabilizers and emulsifiers.

Furthermore, there is a need for a ready-to-use shelf-stable composition for preparing frozen confections at home which is devoid of stabilizers, emulsifiers and egg yolk and which is ready for quick preparation followed by immediate consumption.

### SUMMARY OF THE INVENTION

An object of the present invention relates to a shelf-stable composition for the preparation of frozen confections, which is devoid of added stabilizers and emulsifiers.

In particular, it is an object of the present invention to provide a composition to be used for the preparation of a frozen confection which is devoid of added emulsifiers and stabilizers and at the same time has a creamy and refreshing smooth texture.

Over the recent years, consumers of frozen confections are becoming more and more demanding and conscious about what to eat and consumers tend to prefer products with fewer additives or ideally totally devoid of additives. Thus, consumers are more and more seeking products that contain a minimum of ingredients on their label, i.e. having a “clean” label. By formulating products without added stabilizers and emulsifiers, the inventors of the present invention satisfy both consumer needs. Further, some natural emulsifiers, such as egg yolk, have the drawback of comprising allergens. It may therefore also be advantageous to have a solution which avoids these natural emulsifiers.

Thus, one aspect of the invention relates to a shelf-stable composition for the preparation of a frozen confection comprising: (i) a sweetening agent; (ii) a dairy fat; and (iii) one or more polysaccharide having a Dextrose Equivalent (DE) value of maximum 40; with the proviso that the composition does not comprise added emulsifiers or stabilizers.

The advantage of a shelf-stable composition is to get rid of the frozen distribution and facilitate storage, handling and distribution of a product which can be used at any time with an easy preparation.

The inventors of the present invention has surprisingly found out that with the composition according to the present invention a refreshing frozen confection with a smooth and creamy texture can be prepared.

Besides, the consumers' demand of products with a clean label, i.e. free of additives such as emulsifiers and stabilizers, are met.

The present invention provides a shelf-stable composition for preparing frozen confections where all components are pre-blended. The product obtained starting from the composition of the invention and mixing it with ice and an edible liquid e.g. in a blender has a pleasant whipped texture and a refreshing creamy taste, where the nutrient and caloric value can easily be customized to the customers wishes, since no addition of fat, such as vegetable fat, is present.

The compositions according to the invention are shelf stable, convenient to use, cost effective and do not require any frozen storage. Besides, the composition can furthermore be fortified with micronutrients.

Another aspect of the present invention relates to a method of preparing a frozen confection comprising the steps of:

(i) providing the said composition for preparing a frozen confection;

(ii) providing ice;

(iii) providing an edible liquid;

(iv) mixing the ingredients to a mixture and blend the mixture.

Yet another aspect of the present invention is to provide a frozen confection comprising said composition for frozen confections, ice and an edible liquid.

In general, the various aspects of the invention may be combined and coupled in any way possible within the scope of the invention. These and other aspects, features and/or advantages of the invention will be apparent from and elucidated with reference to the embodiments described hereinafter.

The present invention will now be described in more detail in the following.

### DETAILED DESCRIPTION OF THE INVENTION

An aspect of the invention relates to a composition for the preparation of a frozen confection.

However, prior to discussing the present invention in further details, the following terms and conventions will first be defined.

In the context of the present invention, mentioned percentages are weight/weight percentages unless otherwise stated.

The term “and/or” used in the context of the “X and/or Y” should be interpreted as “X”, or “Y”, or “X and Y”.

Unless defined otherwise, all technical and scientific terms used herein have the same meaning as commonly understood by one of ordinary skill in the art (e.g. in frozen confectionery manufacture). Definitions and descriptions of various terms and techniques used in frozen confectionery manufacture are found in ice Cream, 6^{th} Edition, Robert T Marshall, H. Douglas Goff and Richard W Hartel (2003), Kluwer Academic/Plenum Publishers.

### Frozen Confections:

In the context of the present invention the term “frozen confection” means a confectionery product comprising ice crystals distributed throughout a sweetened and/or flavoured aqueous product and typically having a refreshing and cooling effect with a nice appearance.

Frozen confections include water in the form of ice crystals and are for consumption in a frozen or semi-frozen state, i.e. under conditions wherein the temperature of the product is less than 0° C., and preferably under conditions wherein the product comprises a significant amount of ice crystals. The water present in frozen confections as ice crystals can either be present as water as such or as water in milk or in a juice.

In an embodiment of the invention the frozen confection may be selected from the group consisting of ice cream, low fat ice cream, milk ice, sherbet, frozen yoghurt, smoothies and slush beverage.

The term “milk ice” refers to milk based products with ice crystals evenly distributed throughout the product. The water content in a milk ice may vary and the texture of the finished product will vary depending on the water content.

The term “slush beverage” does in the context of the present invention mean a beverage with ice crystals evenly distributed throughout the beverage. A slush beverage product is in a semi frozen state, such that not all water in the product is frozen, but only a part. The slush beverage may be any liquid product comprising ice crystals in it, for example a smoothie or a slush ice.

The term “smoothie” does in the context of the present invention mean an slush beverage comprising a blend of fresh and/or frozen fruit, fruit juice and frozen yoghurt and/or sherbet.

It is thus envisioned that the frozen confection may be a combination of different types of conventional frozen confectioneries, such as a combination of frozen ice cream and milk ice, or a combination of frozen low fat ice cream and a slush beverage.

In some embodiments of the invention, the frozen confection is a low fat ice confection. The low fat frozen confection normally comprises at most 10% fat by weight.

In an embodiment, the frozen confection is an ice cream.

In an embodiment of the invention, the frozen confection is a smoothie.

In still another embodiment of the invention, the frozen confection is a low fat ice cream.

In a further embodiment of the invention, the frozen confection is iced milk.

In still another embodiment of the invention, the frozen confection is a slush beverage.

### Sweetening Agent:

In the context of the present invention, the term “sweetening agent” means any compound bringing sweetness to a product. The sweetening agent enhances the flavour of the frozen confection prepared from the composition.

In an embodiment of the present invention the sweetening agent are selected from the group consisting of sugar, sugar alcohol, natural sweetener, artificial sweetener or combinations thereof.

Sugar is defined as commonly used and naturally occurring carbohydrates (mono- and disaccharides) with a sweetening effect. Examples of sugar include table sugar (sucrose/saccharose), fructose, lactose, glucose, dextrose, maltose, threalose, honey, syrups or a combination thereof.

In a preferred embodiment of the invention, the sweetening agent is sucrose, such as crystalline sucrose.

The calorie content of sucrose is about 4 kcal/g.

Sugar alcohols, which are also known as polyols, polyhydric alcohols or polyalcohols, is a hydrogenated form of carbohydrate, whose carbonyl group (aldehyde or ketone, reducing sugar) has been reduced to a primary or secondary hydroxyl group. Sugar alcohols are commonly used for replacing sugar in foodstuffs, often in combination with artificial sweeteners to counter the relative low sweetness.

In an embodiment of the present invention, the sugar alcohol is selected from the group of maltitol, mannitol, sorbitol, xylitol, isomalt, lactitol, lactitol, erythritol or a combination thereof.

Disaccharides and monosaccharides can both form sugar alcohols. However, sugar alcohols derived from disaccharides (e.g. maltitol and lactitol) are not entirely hydrogenated because one aldehyde group is available for reduction.

The calorie content of sugar alcohols ranges between about 1.5 up to about 4 kcal/g—except some sugar alcohols, such as e.g. erythritol which contributes 0.2 kcal/g. Even though erythritol has a low energy content, this sugar alcohol is normally not applicable for use in frozen confections due to its “cooling” effects which is normally not applicable within production of frozen confections.

This low calorie property makes sugar alcohols popular sweeteners among diabetics and people on low-carbohydrate diets.

A natural sweetener is in the context of the present invention a sweetener which comes from the nature and which has not been altered too much from how it was found in the nature, i.e. it has not undergone any complicated processing or refining process.

In an embodiment of the invention, the natural sweetener is stevia and/or agave.

Stevia is a herb which comes from a small shrub of the sunflower family, native in South America. Stevia is about 300-400 times sweeter than table sugar (sucrose) and contains no calories. Stevia is not metabolized by the human body and does therefore not raised insulin levels. Stevia may be used as a juice or extract.

Agave (also called agave nector or agave syrup) is a sweetener produced from the juice of the core of the agave plant, a plant growing in South Africa and Mexico. Agave may be used as a juice or extract.

Agave nectar is sweeter than honey, though less viscous.

Agave nectar is 1.4 to 1.6 times sweeter than table sugar (sucrose).

Honey is made from bees from the nectar of flowers. It is a ready-made sweetener that contains traces of nutrients

A syrup may be made from any sweetener, for example from maple to make maple syrup. Maple syrup comes from the sap of maple trees, which is collected, filtered and boiled down to extremely sweet syrup with a distinctive flavour. Maple syrup contains fewer calories than honey, but a higher concentration of minerals, such as manganese and zinc.

In an embodiment of the invention, the sweetening agent is made of maple syrup.

Artificial sweeteners are also called synthetic sweeteners or high intensive sweeteners.

In an embodiment of the present invention, the artificial sweetener is selected form the group of acesulfame, alitame, aspartame, aspartame-acesulfame salt, cyclamate, neotame, saccharin, sucralose, thumatin or a combination thereof. Artificial sweeteners are perceived as manifold more sweet than table sugar and their energy contribution is therefore neglible.

Sweetening intensities may vary according to different assay conditions and/or sensory panels.

In an embodiment of the invention the sweetening agent is present in an amount of about 0.3-90% by weight, such as 0.5-85% by weight, preferably 1-80% by weight.

The amount of sweetening agent is of course dependent of which type of sweetening agent is used. If an artificial sweetener is used as the sweetening agent, a low amount will be used as compared to when table sugar (sucrose) is used as the sweetening agent, since the artificial sweetener is many fold sweeter than sucrose.

Thus, in an embodiment of the invention, the sweetening agent is present in an amount of 20-90% by weight, such as 30-90% by weight, and preferably 40-85% by weight, such as 50-85% by weight, and even more preferably 60-85%, such as 70-80% by weight.

In another embodiment of the invention, artificial sweeteners are used as the sweetening agent is present in an amount of 0.3-10% by weigh, such as 0.5-7% by weight, preferably 0.5-5% by weight.

Artificial sweeteners are used at very low level because it has high relative sweetness than sucrose.

In another embodiment of the invention, sugar alcohols are used as the sweetening agent in an amount of 0.1-15% by weight, such as 0.3-10% by weight, preferably 0.5-8% by weight, such as 0.7-7% by weight, even more preferably 1-5% by weight

Sugar alcohols at high levels will have laxative effect. Thus, the amount of sugar alcohols should not be too high.

The sweetening agent according to the present invention may be used as a combination of two or more sweetening agent, for example a combination of one or more sugars and one or more artificial sweeteners, or a combination of one or more sugar alcohols and one or more artificial sweeteners, or a combination of one or more sugar and one or more sugar alcohols. Further, the sweetening agent according to present invention may comprise one or more sugars, one or more sugar alcohols and one or more artificial sweeteners.

The amount of sweetening agent will naturally depend of which sweetening agents are used and how sweet a taste is wished of the prepared frozen confection product.

Further, the choice of sweetening agent is dependent of whether or not a low calorie product is desired or not. When a low calorie product is desired, a part or all of sugar is substituted with artificial sweetener and/or sugar alcohols. If a diabetic product is desired, no sugar is present, but only sugar alcohols and/or artificial sweeteners.

### Dairy Fat:

In the context of the present invention, the dairy fat may be in any form, such as any concentrate, paste, gel, liquid, powder or granulate.

The dairy fat will be a source of fat to the composition, and the content of fat will depend of which type of dairy fat component is used. However, it is necessary to use a dairy fat as fat source, since any conventional vegetable fat used will produce a product where fat is crystalized, because there are no emulsifiers in the composition to emulsify fat and water. Thus, if vegetable fat is used in the composition an undesirable product will be obtained with crystals of fat.

In an embodiment of the present invention, the dairy fat is selected from the group of buttermilk, yoghurt, full milk, whole milk, lactose free milk or a combination thereof. The dairy fat may also be added as cream, butter or pure milk fat. Generally, the higher the fat content of the dairy fat is and the amount present in the composition, the richer is the frozen confection prepared from the composition.

The dairy fat component in the composition will give a frozen confection prepared from the composition smoothness and creaminess.

In a preferred embodiment the dairy fat is a milk powder.

In still a preferred embodiment of the invention, the dairy fat is a milk powder selected from the group of buttermilk powder, yoghurt powder, full milk powder, whole milk powder, anhydrous milk fat powder, or a combination thereof.

In a further preferred embodiment of the invention, the milk powder is buttermilk powder, such as sweet cream buttermilk powder.

In an embodiment of the invention the dairy fat is present in an amount of 0.5-50% by weight, such as 1-45% by weight, in particular 3-40% by weight, such as 5-30% by weight, preferably, 5-20% by weight, such as 6-18% by weight, even more preferably 7-15% by weight, such as 8-13% by weight.

Polysaccharides with a Dextrose Equivalent (DE) Value of Maximum 40:

In the context of the present invention, the term “(DE)” is a measure of the amount of reducing sugars present in a sugar product, relative to glucose, expressed as a percentage on a dry basis. For example, a maltodextrin with a DE of 10 would have 10% of the reducing power of dextrose (DE=100), while sucrose with a DE of 120, would have 1.2 times the reducing power.

In another embodiment of the invention, the polysaccharide having a DE at maximum 40 is selected from the group of maltodextrin, starch, glucose syrups or a combination thereof.

In a preferred embodiment of the invention, the polysaccharide is tapioca maltodextrin

The polysaccharide used have a Dextrose Equivalent (DE) value at maximum 40, such as at maximum 30, preferably at maximum 25, such as at maximum 20, even more preferably at maximum 15, such as at maximum 10.

Maltodextrin have a DE value varying from 3-20, with tapioca maltodextrin being below 10. Glucose syrups have a DE value about 20, while starch is close to zero. Glucose and dextrose have a DE value about 100. The polysaccharides may also be dextrins in general, other than maltodextrin. Dextrins in general have a DE value from 1-13.

The polysaccharide having a DE value of maximum 40 will contribute with giving the frozen confection prepared viscosity and creaminess, such as a creamy mouth feel.

The amount of polysaccharide is preferably present in the composition in an amount of 1-50% by weight, such as 2-40% by weight, preferably 3-30% by weight, for example 3-20% by weight, such as 3-12 by weight, such as 4-12% by weight, even more preferably 4-10% by weight.

If the composition comprises no sugar as sweetening agent, the amount of polysaccharides are preferably in the amount of 5-30% by weight, such as 10-25% by weight, for example 15-22% by weight.

### Emulsifiers/Stabilizers:

An aspect of the present invention is that the composition does not comprise added emulsifiers or stabilizers.

In the context of the present invention, the term “emulsifier” means any conventional emulsifier normally used to emulsify food product, such as monoglycerides, diglycerides, propylene glycol esters, lecithin and polysorbates.

Egg yolk comprises phospholipids, especially lecithin and is therefore also considered as emulsifier in the context of the present invention.

Thus, the composition according to the present invention is also free form egg yolk and is free of any lecithin.

The term “stabilizer” means in the context of the present invention any conventional used stabilizer normally used for stabilizing frozen confections, such as agar, gelatine, gum acacia, pectin, guar gum, locust bean gum, tara gum, gum tragacanth, xanthan, carrageenan, seaweed, carboxymethyl cellulose, microcrystallincellulose, sodium alginate, carob gum, guar gum and alginate.

### Milk Solid Non-Fat:

In an embodiment of the invention, the composition further comprises milk solids-non-fat (MSNF).

In another embodiment of the invention, the composition comprises milk solids-non-fat in an amount of 1-20% by weight.

In the context of the present invention, the term “milk solids-non-fat” relates to solid material that can be derived from milk, and which solid material is non-fat. MSNF mainly contain lactose, casein, globulin and albumin.

Thus, the MSNF add proteins to the composition for the preparation of a frozen confection, but also lactose.

In an embodiment of the invention, milk solids-non-fat are selected from the group consisting of concentrated defatted skim milk, defatted skim milk powder, whey powder, whey protein powder, whey protein concentrate and whey protein isolate.

The milk solids-non-fat give body to the frozen confection and help develop smoothness. Further, MSNF bring milky-ness to a frozen confection. The MSNF do not much enhance flavour, but they increase viscosity and resistance to melting as well as lowering the freezing point. The milk solid non-fat may also cause formation of lactose crystals which gives an icy texture. The composition must therefore not have too much non-fat milk solids present to avoid lactose crystal formation. The presence of lactose crystals in an frozen confection entails a so-called “sandy” structure, which is undesirable, but this phenomenon has nothing in common with the hardness/softness properties of the ice cream.

In a further embodiment of the invention, the composition comprises milk solids-not-fat in an amount of 3-17% by weight, such as 5-15% by weight, preferably, 6-12% by weight, even more preferably 8-12% by weight.

In an embodiment of the invention, the composition is in a solid form.

The solid form of the composition may for example be a granulate, powder or crystalline form

In a preferred embodiment of the invention, the composition is in the form of a powder.

The composition may also be in the form of a concentrate, liquid, paste, syrup or gel.

### Flavouring Agent:

The composition may further comprise a flavouring agent.

Flavouring agents may also be called “flavours” or “aromatic agents” or aromatic “compounds”.

Flavouring agents might be used alone or in any possible combination in connection with the present invention. Flavouring agents used in the present invention may be any natural flavouring agent or any artificial flavouring agent.

The flavouring agent may be in the form of a flavour and/or extracts and/or aromatic oils.

The flavouring agent may be derived from fruit and berries (e.g. banana, raspberry, strawberry, apricot, blueberry, apple, pear, mango, papaya, citrus, orange etc.), from nuts (e.g. hazel nuts, almonds, pine nuts, pistachio, cashew nuts, etc.), spices (e.g. chai, basil, cardamom, cinnamon, thyme, etc.), flowers (e.g. rose, elderflower, etc.), roots (e.g. liquorice/licorice), plants (e.g. vanilla, mint, fir, tea, etc.), as well as other sources (e.g. honey). Flavouring agents furthermore comprise ingredients/flavours such as cocoa, chocolate, coffee, mocha, caramel, caramel essence, nougat, nougat essence, marzipan, almond essence, oils, liquor, brandy, rum, port, whiskey, wine etc.)

In an embodiments of the invention, the composition comprises flavouring agents in an amount from 0.2-20% by weight, such as 0.2-15% by weight, for example 0.5-10% by weight, such as 0.5-5% by weight, preferably, 0.5-3% by weight, such as 0.7-3% by weight, even more preferably 0.7-1.2% by weight.

In a preferred embodiment, the flavour is coffee powder.

In a preferred embodiment, the flavour is vanilla flavour powder.

In a preferred embodiment, the flavour is cocoa powder.

### Colouring Agent:

The composition may further comprise a colouring agent.

Food colours are added to the composition to give a frozen confection prepared hereof a delicious colour. The colours are often associated with different group of flavours. As an example, red colour favours perception of e.g. the taste of red fruits.

In a preferred embodiment of the invention, the composition comprises:

(i) a sweetening agent in an amount of about 70-80% by weight;

(ii) a dairy fat present in an amount of about 8-13% by weight; and

(iii) one or more polysaccharide having a Dextrose Equivalent value of maximum 40, wherein said polysaccharide is present in an amount of 7-9% by weight.

In another preferred embodiment of the invention, the composition comprises:

(i) a sweetening agent in an amount of about 70-80% by weight;

(ii) a dairy fat present in an amount of about 8-13% by weight;

(iii) one or more polysaccharide having a Dextrose Equivalent value of maximum 40, wherein said polysaccharide is present in an amount of 7-9% by weight; and

(iv) milk solids-non-fat present in an amount of about 8-12% by weight.

In another embodiment of the invention, the composition consist of

(i) a sweetening agent;

(ii) a dairy fat;

(iii) one or more polysaccharide having a Dextrose Equivalent value of maximum 40;

(iv) optional milk solid non-fat; and

(v) optional flavours and colours

In a further preferred embodiment of the invention, the composition comprises

(i) a sugar in an amount of 70-80% by weight;

(ii) buttermilk powder in an amount of 8-13% by weight;

(iii) maltodextrin in an amount of 7-9% by weight;

(iv) whey protein concentrate in an amount of 8-12%; and

(v) flavours

For a person skilled in the art, it should be easy to translate these preferred embodiments of the composition according to the invention into other frozen confections, e.g. smoothies, iced confection, low calorie confections and other related products. The description of the invention should therefore not be seen as limiting in the art.

Yet an aspect of the present invention relates to a method of preparing a frozen confection comprising the steps of:

(i) provide a composition according to the invention.

(ii) provide ice

(iii) provide an edible liquid

(iv) mix the ingredients to a mixture and blend the mixture.

### Ice:

In the context of the present invention the term “ice” means any frozen edible pieces with variable amounts of frozen water, and which is suitable for being present in a frozen confection. Pure ice contains 100% water, while frozen edible pieces, such as fruit pieces contain less water.

Examples of “ice” includes but are not limited to frozen water (pure ice), frozen juice, such as fruit juice or vegetable juice, frozen milk, or ice milk, frozen chocolate pieces, or frozen fruits and frozen berries or combinations thereof.

Examples of frozen milk are skim milk, whole milk, full milk and low-fat milk.

The form of the “ice” may be as cubes, crushed, a slush or frozen fruit or berries either whole or as pieces.

### Edible Liquid:

The term “edible liquid” means any liquid which is edible and which is suitable for being present in a frozen confection.

In an embodiment of the invention the edible liquid is selected form the group of milk, yoghurt, water or juice.

The juice may be from any fruit, berry or vegetable.

Milk as edible liquid may be skim milk, whole milk, full milk, low-fat milk, buttermilk, flavoured milk, lactose free milk or coconut milk.

The lactose free milk may be soy milk.

The flavoured milk may for example be strawberry milk or cocoa milk.

The blending of the mixed ingredients in method according to the invention may be for at least 15 seconds, such as for at least 30 seconds, preferably for at least 45 seconds such as for at least 1 minute.

In the context of the present invention, the term “blend” means mixing so that the ingredients are indistinguishable from one another.

In an embodiment of the invention, the method of preparing a frozen confection comprises the composition according to the invention present in an amount of 15-40% by weight, ice present in an amount of 20-60% by weight and an edible liquid present in an amount of 20-60% by weight.

In a further embodiment of the invention, the method of preparing a frozen confection comprises the composition according to the invention present in an amount of 20-30% by weight, ice present in an amount of 30-45% by weight and an edible liquid present in an amount of 30-45% by weight.

In a further aspect, the invention relates to a frozen confection comprising the composition according to the invention, ice and an edible liquid.

In an embodiment, the frozen confection comprises the composition according to the invention present in an amount of 20-30% by weight, ice present in an 20 amount of 30-45% by weight and an edible liquid present in an amount of 30-45% by weight.

In another embodiment, the edible liquid is milk.

The composition is preferably made by mixing all ingredients as a dry blend.

It should be noted that embodiments and features described in the context of one of the aspects of the present invention also apply to the other aspects of the invention.

All patent and non-patent references cited in the present application, are hereby incorporated by reference in their entirety.

The invention will now be described in further details in the following non-limiting examples.

### EXAMPLES

### Example 1 Composition for a Vanilla Frozen Confection

The following composition is used as a composition for preparing homemade ice cream:
18-20% Dry sugar
3% Sweet Cream buttermilk powder
2% tapioca maltodextrin
2.6% whey protein concentrate (30% protein)
0.2% powdered vanilla flavour

The ingredients are mixed and subjected to a dry blend operation to make the composition.

### Example 2 Composition for Chocolate Frozen Confection

18-20% Dry sugar
3% Sweet Cream buttermilk powder
2% tapioca maltodextrin
2.6% whey protein concentrate (30% protein)
1% cocoa powder
0.2% natural powder of sweet cream flavour

The ingredients are mixed and subjected to a dry blend operation to make the composition.

### Example 3 Composition for Coffee Frozen Confection

18-20% Dry sugar
3% Sweet Cream buttermilk powder
2% tapioca maltodextrin
2.6% whey protein concentrate (30% protein)
0.5% coffee powder
0.2% natural powder of sweet cream flavour

The ingredients are mixed and subjected to a dry blend operation to make the composition.

### Example 4 Method of Making a Frozen Confection

The container of a blender is filled 37 grams of ice cubes. 37 grams of milk is filled in the container together with the ice cubes and 26 grams of the composition of example 1 is added into the mixture of ice cubes and milk.

The mixture is then blended for 1 minute and a nice soft ice cream with vanilla flavour is made with a smooth, soft and creamy texture.

1. A shelf-stable composition for the preparation of a frozen confection comprising:
a sweetening agent;
a dairy fat;
one or more polysaccharide having a Dextrose Equivalent (DE) value of maximum 40; and
the composition does not comprise added emulsifiers or stabilizers.

2. The composition according to claim 1, wherein the sweetening agent comprises 0.3-90% by weight.

3. The composition according to claim 1, wherein the dairy fat comprises 0.5-50% by weight.

4. The composition according to claim 1, wherein the one or more polysaccharide comprise 2-50% by weight.

5. The composition according to claim 1, wherein the composition comprises milk solids-non-fat in an amount of 1-20% by weight.

6. The composition according to claim 1, wherein the dairy fat is a milk powder.

7. The composition according to claim 1, wherein the polysaccharide is selected from the group consisting of maltodextrin, starch, glucose syrups and combinations thereof.

8. The composition according to claim 5, wherein the milk solid non-fat is selected from the group consisting of concentrated defatted skim milk, defatted skim milk powder, whey powder, whey protein powder, whey protein concentrate, whey protein isolate and combinations thereof.

9. The composition according to claim 1, wherein the composition comprises:
a sweetening agent comprising 70-80% by weight;
a dairy fat comprising 8-13% by weight; and
one or more polysaccharide having a Dextrose Equivalent value of maximum 40, wherein the polysaccharide is present in an amount of 7-9% by weight

10. The composition according to claim 9, wherein the composition further comprises milk solid non-fat present in an amount of 8-12% by weight.

11. A method of preparing a frozen confection comprising the steps of:
providing a composition comprising a sweetening agent, a dairy fat, one or more polysaccharide having a Dextrose Equivalent (DE) value of maximum 40, and the composition does not comprise added emulsifiers or stabilizers;
providing ice;
providing an edible liquid; and
mixing the ingredients to a mixture and blend the mixture.

12. The method according to claim 11, wherein the edible liquid is selected from the group consisting of milk, yoghurt, water, juice and combinations thereof.

13. The method according to claim 11, wherein ice is selected from the group consisting of frozen water, frozen juice, frozen milk, ice milk, frozen chocolate, frozen fruit or frozen berries and combinations thereof.

14. The method according to claim 11, wherein the composition comprises 15-40% by weight, ice comprises 20-60% by weight and an edible liquid comprises 20-60% by weight.

15. A frozen confection comprising a composition comprising:
a sweetening agent;
a dairy fat;
one or more polysaccharide having a Dextrose Equivalent (DE) value of maximum 40; and
the composition does not comprise added emulsifiers or stabilizers, ice, and an edible liquid.
